(19) United States
(12) Patent Application Publication
(10) Pub. No.: US 2014/0286604 A1
(43) Pub. Date: Sep. 25, 2014

(54) ENDO-MICROSCOPIC PROBE BASED ON NON-RESONANT SCANNING METHOD USING OPTICAL FIBER

(71) Applicant: Korea Advanced Institute of Science and Technology, Daejeon (KR)

(72) Inventors: DaeGab GWEON, Daejeon (KR); Duk Ho Do, Daejeon (KR); Young Duk Kim, Daejeon (KR); Hyun Chang Kim, Daejeon (KR); Dong Ryoung Lee, Daejeon (KR); Hyeong Jun Jeong, Daejeon (KR)

(73) Assignee: Korea Advanced Institute of Science and Technology, Daejeon (KR)

(21) Appl. No.: 14/195,853

(22) Filed: Mar. 4, 2014

(30) Foreign Application Priority Data
Mar. 22, 2013 (KR) 10-2013-0031131

(51) Int. Cl. G02B 6/10

(52) U.S. Cl. CPC G02B 6/10
USPC 385/13

(57) ABSTRACT

Disclosed is an endo-microscopic probe based on a non-resonant scanning method using an optical fiber which includes a housing configured to have a specific size, an optical fiber placed within the housing and configured to transfer a light source, a tubular piezoelectric element configured to surround the optical fiber within the housing, include a guide unit for guiding a movement of the optical fiber at the end of the tubular piezoelectric element, and provide a deformation value according to a deformation amount to the optical fiber through the guide unit using an external power source, and a lens unit placed within the tubular piezoelectric element, fixed to an end of the housing, and configured to transfer light output from an end of the optical fiber to a sample.

### CROSS REFERENCE TO RELATED APPLICATION

The present application claims the benefit of Korean Patent Application No. 10-2013-0031131 filed in the Korean Intellectual Property Office on Mar. 22, 2013, the entire contents of which are incorporated herein by reference.

### BACKGROUND OF THE INVENTION

1. Technical Field

The present invention relates to an endo-microscopic probe based on a non-resonant scanning method using an optical fiber and, more particularly, to an endo-microscopic probe capable of measuring a shape of tissue by being inserted into and coming in contact with an organism and to the scanning method and structure of an endo-microscope using the precise fiber-optic driving mechanism of a piezoelectric element in order to obtain an image of a plan area.

2. Description of the Related Art

Today, endoscopic equipment used in common hospitals is being widely used to diagnose diseases, such as carcinoma and polyps, by obtaining and analyzing images of the large intestine and within the abdominal wall of a human being. However, common endoscopic equipment uses a Charge Coupled Device (CCD) and has a disadvantage in that it has low resolution because it measures a relatively wide area of several cm or more. Accordingly, researches are being carried out on an endo-microscope probe capable of obtaining a high-resolution image of a cell size level in order to early diagnose diseases.

An endo-microscopic probe is being developed to have a smaller probe size while maintaining high-resolution performance so that the probe can be directly inserted into the human body or combined with a channel within commercial endoscopic equipment. In order to implement high resolution, a driving mechanism for beam scanning needs to be inserted into the endo-microscope. A current driving mechanism may basically include two types. The first type is a method using a small microelectromechanical systems (MEMS) mirror. In this method, beam scanning is implemented by the rotation of the mirror, such as a galvanometer scanning mirror. The MEMS mirror itself can be fabricated in a small size, but it is difficult to fabricate an endo-microscopic probe having a diameter of 5 mm or less because an electronic circuit unit for driving the MEMS mirror is necessary. The second type is an optical fiber scanning method using a piezoelectric element.

In general, a cylindrical 4-partition piezoelectric element is used. When a sine-wave voltage signal, such as the resonant frequency of an optical fiber combined with the end of the piezoelectric element is received, the optical fiber repeatedly moves with a great amplitude. Such a method is advantageous in that it can reduce the diameter of the endo-microscopic probe up to 2 mm using the cylindrical piezoelectric element. However, the method is disadvantageous in that scanning speed is limited because only scanning of a resonant form is possible and partial scanning at a desired position is impossible.

### PRIOR ART DOCUMENT

### Patent Document

(Patent Document 1) KR 10-1122371

(Patent Document 2) KR 10-0498805

(Patent Document 3) KR 10-1120534

### SUMMARY OF THE INVENTION

Accordingly, the present invention has been made keeping in mind the above problems occurring in the prior art, and an object of the present invention is to provide an endoscopic probe using a non-resonant scanning method capable of scanning speed control and selective scanning and an endo-microscopic probe capable of amplifying a narrow scanning area that is an advantage of a non-resonant method.

In accordance with an aspect of the present invention, an endo-microscopic probe includes a housing configured to have a specific size, an optical fiber placed within the housing and configured to transfer a light source, a tubular piezoelectric element configured to surround the optical fiber within the housing, include a guide unit for guiding a movement of the optical fiber at the end of the tubular piezoelectric element, and provide a deformation value according to a deformation amount to the optical fiber through the guide unit using an external power source, and a lens unit placed within the tubular piezoelectric element, fixed to an end of the housing, and configured to transfer light output from an end of the optical fiber to a sample.

Furthermore, the tubular piezoelectric element includes a 4-partition tubular piezoelectric element.

Furthermore, the lens unit is fixed to a fixing unit provided at the end of the housing.

Furthermore, the guide unit has a structure having a thickness of 1˜100 μm.

Furthermore, the guide unit has a cross-shaped structure, and the optical fiber is supported by the cross-shaped structure.

Furthermore, the housing has a cylindrical or rectangular parallelpiped shape.

Furthermore, the optical fiber is replaceable with a photonic crystal fiber.

In accordance with an aspect of the present invention, an endo-microscopic probe includes a housing configured to have a specific size, an optical fiber placed within the housing and configured to transfer a light source, a tubular piezoelectric element configured to surround the optical fiber within the housing, include a guide unit for guiding a movement of the optical fiber at the end of the tubular piezoelectric element, and provide a deformation value according to a deformation amount to the optical fiber through the guide unit using an external power source, and a lens unit spaced apart from the tubular piezoelectric element, fixed to the end of the housing, and configured to transfer light output from the end of the optical fiber to a sample.

Furthermore, the tubular piezoelectric element includes a 4-partition tubular piezoelectric element.

Furthermore, the guide unit has a cross-shaped structure, and the optical fiber is supported by the cross-shaped structure.

### BRIEF DESCRIPTION OF THE DRAWINGS

FIG. 1 is a cross-sectional view of an endo-microscopic probe in accordance with an embodiment of the present invention;

FIG. 2 is a perspective view showing an internal structure of the endo-microscopic probe from which a housing has been removed in accordance with an embodiment of the present invention;

FIG. 3 is a state diagram showing a change of a shape when the endo-microscopic probe is scanned in accordance with an embodiment of the present invention; and

FIG. 4 is a cross-sectional view showing the structure of the endo-microscopic probe which can be minimized in accordance with an embodiment of the present invention.

### DETAILED DESCRIPTION

Hereinafter, an endo-microscopic probe based on a non-resonant scanning method using an optical fiber according to an exemplary embodiment of the present invention is described in detail with reference to the accompanying drawings.

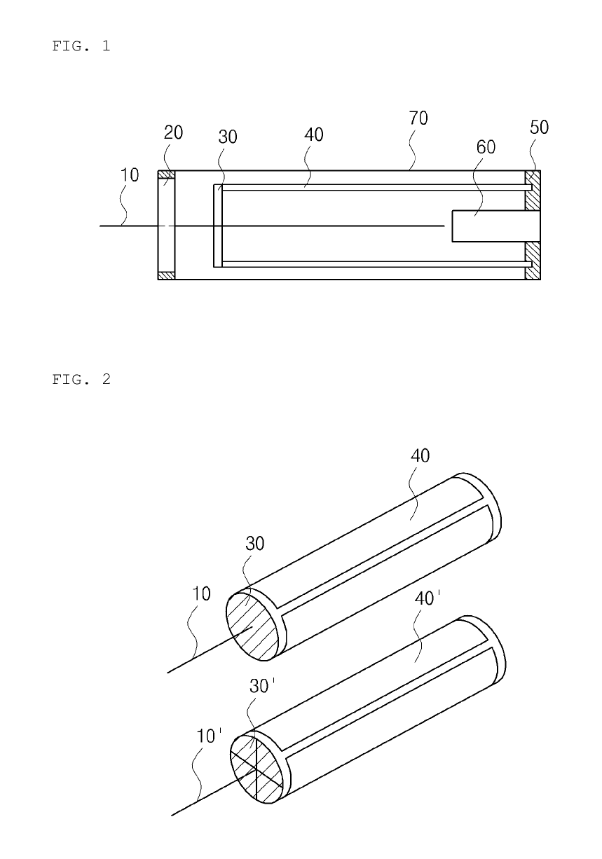

FIG. 1 is a cross-sectional view of the endo-microscopic probe in accordance with an embodiment of the present invention.

The endo-microscopic probe based on a non-resonant scanning method using an optical fiber according to the present invention includes a probe housing 70 configured to have a specific size, an optical fiber 10 placed within the probe housing and configured to transfer a light source, and a guide unit 30 disposed at the end of the probe housing and configured to surround the optical fiber within the probe housing and to guide a movement of the optical fiber. The endo-microscopic probe further includes a tubular piezoelectric element 40 supplied with an external power source and configured to transfer its deformation value according to a deformation amount to the optical fiber 10 through the guide unit 30 and a lens unit placed within the tubular piezoelectric element 40, fixed to the end of the probe housing 70 and configured to transfer light output from the end of the optical fiber 10 to a sample.

The present invention proposes the structure of the endo-microscopic probe using an optical fiber scanning mechanism. The scanning of the optical fiber is performed according to a non-resonant scanning method using the tubular piezoelectric element 40, and a scanning area at the end of the optical fiber is implemented using a lever structure.

A 4-partition tubular piezoelectric element is used as the tubular piezoelectric element 40. A pair of surfaces that face each other is responsible for scanning in one axis in a two-dimensional plane. The optical fiber 10 can be placed at x, y positions by applying four voltage signals V(+x), V(−x), V(+y), and V(−y) to the 4-partition surfaces. For a lever mechanism, a hinge unit for inducing a movement of the optical fiber is combined with the end of the tubular piezoelectric element 40. A deformation amount of the tubular piezoelectric element 40 is transferred to the optical fiber 10 through the hinge unit. The deformation amount is amplified through the lever mechanism, thus inducing a great deformation amount at the end of the optical fiber 10. A light source passing through the center of the optical fiber 10 is scanned and incident on a small lens that has approached the optical fiber 10. The light source condensed by the small lens unit focuses on an object to be measured, light reflected from or excited by the object retraces its path, and the light is incident on the optical fiber 10. Accordingly, information about the object is obtained through the measured light.

The optical fiber 10 may have a core through which light can pass formed in its center and at least one cladding that surrounds the core. The optical fiber 10 may be replaced with photonic crystal fiber which plays a role of the core and the cladding. The optical fiber 10 is combined with an optical fiber fixing unit 20 and is configure to pass through the center of the optical fiber fixing unit 20. The optical fiber fixing unit 20 is combined with the probe housing 70. The probe housing 70 may have an empty cylinder shape or an empty rectangular parallelpiped shape. The probe housing 70 is combined with a lens fixing unit 50, and the lens fixing unit 50 functions to fix the small lens unit 60. Furthermore, the tubular piezoelectric element 40 is disposed within the probe housing 70 by way of the lens fixing unit 50 on one side, and the guide unit 30 is attached to the tubular piezoelectric element 40 on the other side. The guide unit functions to transfer a movement of the tubular piezoelectric element 40 to the optical fiber 1 and may have a thin structure having a thickness of 1˜100 μm. That is, the optical fiber 10 is combined on the basis of the guide unit 30, and the guide unit 30 transfers a movement of the tubular piezoelectric element 40.

In other words, the probe housing 70 is provided at the outermost of the endo-microscopic probe, and the tubular piezoelectric element 40 is placed within the hollow probe housing 70. The optical fiber 10 that provides a light source is inserted from the outside to the inside of the tubular piezoelectric element 40. Here, the fixing unit of the probe housing 70 is fixed, and the front end of the probe housing 70 is fixed by the guide unit 30. The lens unit 60 is fixed to the end of the probe housing 70 on the other side in a direction in which light is output. Accordingly, light radiated from the optical fiber 10 is radiated to a sample through the lens unit 60.

FIG. 2 is a perspective view other than the optical fiber fixing unit 20 and the probe housing 70 in the cross section of FIG. 1.

If the guide unit 30 is cylindrical, the optical fiber 1 passes through the center of the guide unit 30 through a hole having a size corresponding to the diameter of the optical fiber 10. The guide unit 30 and the tubular piezoelectric element 40 may be combined as shown in FIG. 2. A guide unit 30′ may have a cross-shaped structure. The cross-shaped structure has a thickness of 1 to 100 μm and transfers a movement of a tubular piezoelectric element 40′ to an optical fiber 10′.

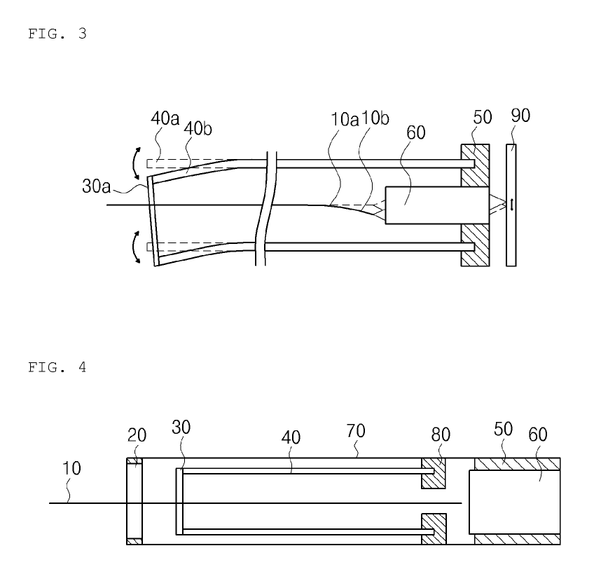

FIG. 3 is a state diagram showing a movement when the endo-microscopic probe is scanned. When voltage is applied to a tubular piezoelectric element 40a, the other end of the tubular piezoelectric element 40a is extended, contracted, and changed into a tubular piezoelectric element 40b because one end of the tubular piezoelectric element 40a is fixed to the lens fixing unit 50. The deformation amount of the tubular piezoelectric element 40b is transferred to an optical fiber 10a combined with a guide unit 30a, so the optical fiber 10a has a movement of an optical fiber 10b. The deformation amount of the optical fiber 10b is amplified due to a lever type structure, and thus the optical fiber 10b has great deformation in front of the lens unit 60. Accordingly, a light source that passes through the optical fiber 10b is scanned, and thus an image of a sample 90 to be finally measured can be obtained by scanning the light source.

FIG. 4 shows a probe having another form. The small lens unit 60 has an external diameter of 0.5 mm-2 mm. If the small lens unit 60 is placed within the tubular piezoelectric element 40, an overall probe diameter is increased. Accordingly, in order to produce a small probe having an external diameter of 2-3 mm, the tubular piezoelectric element 40 having a diameter of 1-2.5 mm may be used. Here, a piezoelectric element fixing unit 80 is separately inserted. Even in this case, the guide unit transfers a movement of the tubular piezoelectric element 40 to the optical fiber 10. The optical fiber 10 is combined with the optical fiber fixing unit 20, and the optical fiber fixing unit 20 is combined with the probe housing 70. The probe housing 70 and the lens fixing unit are also combined, and the small lens unit 60 is disposed within the lens fixing unit 50.

As described above, the endo-microscopic probe according to the present invention is advantageous in that it enables a non-resonant scanning method capable of scanning speed control and selective scanning and thus the endo-microscopic probe can be designed to have a structure for amplifying a narrow scanning area.

The endo-microscopic probe according to the present invention is advantageous in that it can control scanning speed and perform selective scanning in a partial and specific area by overcoming the disadvantages of an existing endo-microscopic probe, such as a difficulty of a reduction in size and only a resonant scanning method. Such an advantage is used in a Fluorescence Recovery After Photobleaching (FRAP) scheme for measuring the diffusion of a sample by applying artificial fluorescent bleaching to a specific area.

Furthermore, control of speed can be easily applied to a tomographic imaging scheme having limited acquisition speed in each point, such as Photo-Acoustic Tomography (PAT) and Optical Coherence Tomography (OCT).

Although the exemplary embodiment of the present invention has been described in order to illustrate the principle of the present invention, the present invention is not limited to the aforementioned construction and operation. Those skilled in the art will appreciate that the present invention may be changed and modified in various ways without departing from the spirit and scope of the present invention. Accordingly, all proper changes and modifications and equivalents thereof should be construed as belonging to the scope of the present invention.

What is claimed is:

1. An endo-microscopic probe based on a non-resonant scanning method using an optical fiber, the probe comprising:
a housing configured to have a specific size;
the optical fiber placed within the housing and configured to transfer a light source;
a tubular piezoelectric element configured to surround the optical fiber within the housing, comprise a guide unit for guiding a movement of the optical fiber at an end of the tubular piezoelectric element, and provide a deformation value according to a deformation amount to the optical fiber through the guide unit using an external power source; and
a lens unit placed within the tubular piezoelectric element, fixed to an end of the housing, and configured to transfer light output from an end of the optical fiber to a sample.

2. The endo-microscopic probe of claim 1, wherein the tubular piezoelectric element comprises a 4-partition tubular piezoelectric element.

3. The endo-microscopic probe of claim 1, wherein the lens unit is fixed to a fixing unit provided at the end of the housing.

4. The endo-microscopic probe of claim 1, wherein the guide unit has a structure having a thickness of 1˜100 μm.

5. The endo-microscopic probe of claim 1, wherein:
the guide unit has a cross-shaped structure, and
the optical fiber is supported by the cross-shaped structure.

6. The endo-microscopic probe of claim 1, wherein the housing has a cylindrical or rectangular parallelpiped shape.

7. The endo-microscopic probe of claim 1, wherein the optical fiber is replaceable with a photonic crystal fiber.

8. An endo-microscopic probe based on a non-resonant scanning method using an optical fiber, the probe comprising:
a housing configured to have a specific size;
the optical fiber placed within the housing and configured to transfer a light source;
a tubular piezoelectric element configured to surround the optical fiber within the housing, comprise a guide unit for guiding a movement of the optical fiber at an end of the tubular piezoelectric element, and provide a deformation value according to a deformation amount to the optical fiber through the guide unit using an external power source; and
a lens unit spaced apart from the tubular piezoelectric element, fixed to an end of the housing, and configured to transfer light output from an end of the optical fiber to a sample.

9. The endo-microscopic probe of claim 8, wherein the tubular piezoelectric element comprises a 4-partition tubular piezoelectric element.

10. The endo-microscopic probe of claim 8, wherein:
the guide unit has a cross-shaped structure, and
the optical fiber is supported by the cross-shaped structure.
